(19) United States
(12) Patent Application Publication
(10) Pub. No.: US 2015/0067359 A1
(43) Pub. Date: Mar. 5, 2015

(54) INFORMATION PROCESSING APPARATUS AND POWER CONTROL METHOD

(71) Applicant: FUJITSU LIMITED, Kawasaki-shi (JP)

(72) Inventor: Akira MORITA, Kawasaki (JP)

(21) Appl. No.: 14/452,015

(22) Filed: Aug. 5, 2014

(30) Foreign Application Priority Data
Sep. 3, 2013 (JP) 2013-182330

(51) Int. Cl. G06F 1/26

(52) U.S. Cl. CPC G06F 1/26
USPC 713/300

(57) ABSTRACT

An information processing apparatus includes a power circuit, a system control circuit, an information processing unit, a device connection port, a first switch, a second switch, and a power control circuit to supply the electric power to the device connection port from the power circuit with the system control circuit booting up the information processing unit when accepting the instruction of the power supply by the first switch, and to supply the electric power to the device connection port from the power circuit with the system control circuit restraining the information processing unit from being booted up when accepting the instruction of the power supply by the second switch in a state of the first switch not accepting the instruction of the power supply.

### CROSS-REFERENCE TO RELATED APPLICATION

This application is based upon and claims the benefit of priority of the prior Japanese Patent Application No. 2013-182330, filed on Sep. 3, 2013, the entire contents of which are incorporated herein by reference.

### FIELD

The present invention relates to an information processing apparatus capable of supplying electric power and a power control method.

### BACKGROUND

In recent years, there has increasingly been a rapid spread of portable devices such as Smartphones and music playback devices. Under such a background, there is also an ongoing spread of an information processing apparatus such as a personal computer with a function enabling a use of a device connection port like a USB (Universal Serial Bus) port as an application for charging a portable device with electricity even in a shutdown state. This function is also called a power-off USB charging function.

For accomplishing the charge from the device connection port in a non-booting state of the information processing apparatus body, it follows that the device connection port is supplied with the electric power in the state of not booting up the information processing apparatus. A technology, which provides different circuits separately for a power source for a system control circuit within the information processing apparatus and a power source for the device connection port, is known as an expedient for attaining this.

On the other hand, if the power source for the system control circuit and the power source for the device connection port are produced by the same circuit, the power sources continue to be supplied even in the state of not booting up the information processing apparatus. Even in the case of not charging the portable device with the electricity, the system control circuit continues to be supplied with the electric power, and consequently power consumption increases though depending on a type of the information processing apparatus. This increase affects retaining time etc. of a battery, which is not preferable in terms of the power consumption. Therefore, a majority of information processing apparatuses in status quo are set in a “Disable” state as setting of the power supply to the device connection port when shipped, and the power consumption is thus restrained. Then, when a user desires to utilize a charge function, the setting of the power supply to the device connection port is changed to an “Enable” state under software control based on user's setting.

### DOCUMENTS OF PRIOR ARTS

### Patent Document

[Patent document 1] Japanese Laid-Open Patent Publication No. 2001-242965
[Patent document 2] Japanese Laid-Open Patent Publication No. 2011-204159
[Patent document 3] Japanese Laid-Open Patent Publication No. 2011-134126

### SUMMARY

One aspect of an embodiment is exemplified by an information processing apparatus. The information processing apparatus includes a power circuit, a system control circuit to be supplied with electric power from the power circuit, an information processing unit configured to be booted up by the system control circuit supplied with the electric power, a device connection port to supply the electric power received from the power circuit to an external device, a first switch to accept a first instruction of power supply to the system control circuit from the power circuit, a second switch to accept a second instruction of the power supply to the device connection port from the power circuit, and a power control circuit to supply the electric power to the device connection port from the power circuit with the system control circuit booting up the information processing unit when accepting the first instruction of the power supply by the first switch, and to supply the electric power to the device connection port from the power circuit with the system control circuit restraining the information processing unit from being booted up when accepting the second instruction of the power supply by the second switch in a state of the first switch not accepting the first instruction of the power supply.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF THE DRAWINGS

FIG. 1 is a view illustrating one example of an information processing apparatus with the device connection port that supports a power-off USB charge;

FIG. 2 is a diagram illustrating an example in the case of generating power for the system control circuit and the power for the device connection port by different power circuits;

FIG. 3 is a diagram illustrating an example in the case of generating the power for the system control circuit and the power for the device connection port by a common power circuit;

FIG. 4 is a diagram illustrating an example of an operation mode of the power circuit when shipping the information processing apparatus;

FIG. 5 is a diagram illustrating an example of the operation mode of the power circuit after setting of the power supply to the device connection port has been changed to an “Enable” state;

FIG. 6 is a diagram depicting a transition of a power supply state of the information processing apparatus when shipped;

FIG. 7 is a diagram depicting a transition of the power supply state of the information processing apparatus on the occasion of changing the setting of the power supply to the device connection port;

FIG. 8 is a diagram depicting a transition of the power supply state of the information processing apparatus by switching ON and OFF a charge button;

FIG. 9 is a diagram of a hardware configuration of the power control circuit according to a comparative example;

FIG. 10 is a diagram illustrating how the power control circuit performs controlling when shut down according to the comparative example;

FIG. 11 is a diagram illustrating how the power control circuit performs controlling when pressing down a power button according to the comparative example;

FIG. 12 is a diagram of a hardware configuration of the power control circuit according a working example;

FIG. 13 is a diagram illustrating one example of how the power control circuit performs controlling when pressing down the charge button according to the working example;

FIG. 14 is a diagram illustrating one example of how the power control circuit performs controlling when pressing down the power button according to the working example;

FIG. 15 is a flowchart illustrating a processing flow of the power control circuit in a case where the power supply to the device connection port is started by pressing down the charge button;

FIG. 16 is a flowchart illustrating a processing flow of the power control circuit when pressing down the power button;

FIG. 17 is a diagram illustrating one example of how the power control circuit performs controlling when pressing down the charge button according to a first modified example;

FIG. 18 is a diagram illustrating one example of how the power control circuit performs controlling when pressing down the power button according to the first modified example; and

FIG. 19 is a diagram illustrating an example of a structure of the device connection port in a second modified example.

### DESCRIPTION OF EMBODIMENTS

As described above, in the case of providing the different power circuits separately for the power source for the system control circuit and the power source for the device connection port, such inconvenience arises that both of a cost and a circuit packaging area for the power circuit for the device connection port increase.

On the other hand, the power source for the system control circuit and the power source for the device connection port are configured by the same power circuit, and the setting of the power supply to the device connection port is switched over under the software control based on the user's setting, which method also causes such inconvenience as to be poor in usability. To be specific, when the user desires to charge the portable device with the electricity in the non-booting state of the information processing apparatus, such a procedure arises that the user temporarily boots up the information processing apparatus, changes the setting of the power supply to the device connection port from the “Disable” state to the “Enable” state and performs the shutdown, resulting in the poor usability.

Furthermore, in the case of keeping the setting of the power supply to the device connection port in the “Enable” state at all times, it follows that the system control circuit consumes futile standby power even when not utilizing the USB charging function.

An embodiment of the present invention will hereinafter be described based on the drawings. A configuration of the following embodiment is an exemplification, and the present invention is not limited to the configuration of the embodiment.

### Power Supply State of Information Processing Apparatus

An information processing apparatus according to one aspect of the embodiment of the present invention includes a charge button. The information processing apparatus, with the charge button being pressed down, transitions to a power supply state that a power-off USB charge is enabled in a state where the information processing apparatus is not yet started. This power supply state is called an S5 state. Hereat, “boot-up restraint setting” in register setting of a system control circuit is set ON beforehand by BIOS (Basic Input/Output System) setup, whereby the information processing apparatus remains in the S5 state, which enables charging from the device connection port without starting a normal system boot-up. Note that the information processing apparatus, when pressing down a power button, transmits a system boot-up notifying signal to the system control circuit in addition to controlling when pressing down the charge button. When the system control circuit receives the system boot-up notifying signal and even when the boot-up restraint setting of the system control circuit is kept ON, the information processing apparatus transitions to the power supply state enabling software such as the BIOS and applications to operate. This power supply state is called an S0 state.

The information processing apparatus, when the charge button is again pressed down after utilizing the power-off USB charging function, transitions to a state of not being supplied with the power similarly when shipped or when shut down. This power supply state is called a G3 state. In the G3 state, the power-off USB charging function is disabled. The information processing apparatus transitions to the G3 state and is thereby enabled to restrain unnecessary power consumption. Hereinafter, a function of supplying the power to the device connection port such as a USB port without conducting the system boot-up of the information processing apparatus will be termed the power-off USB charging function. It does not, however, mean that an application of the power supplied by dint of the power-off USB charging function is limited to a charging purpose.

### Concerning Power Circuit

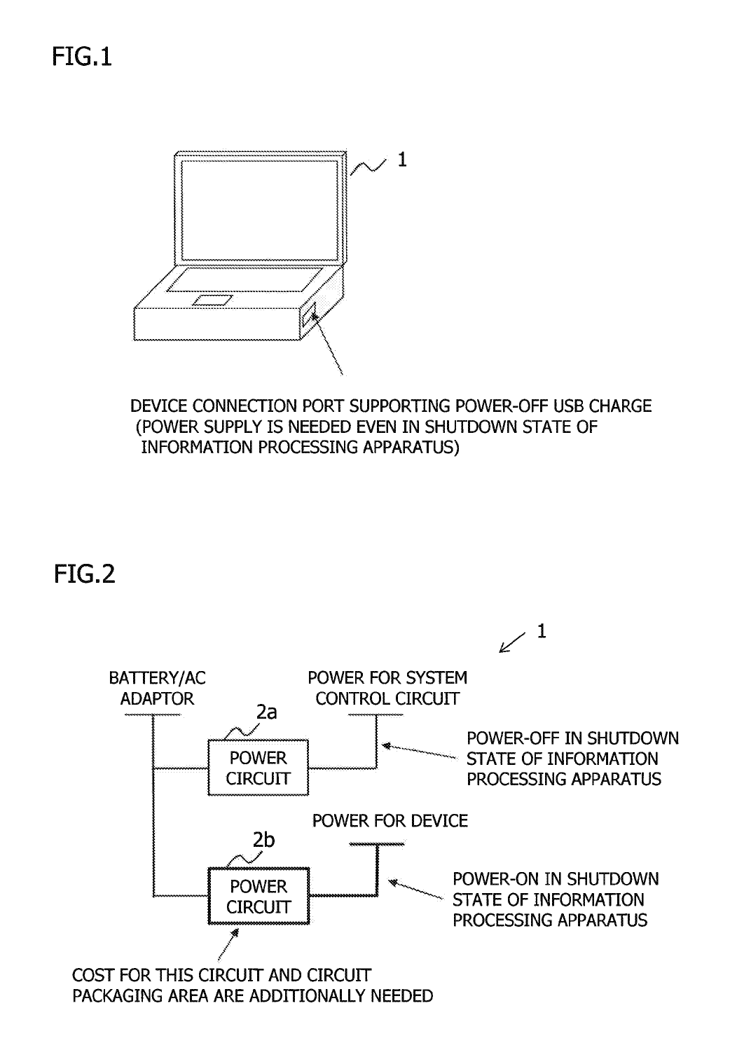

FIG. 1 is a view illustrating one example of the information processing apparatus with the device connection port that supports the power-off USB charge. A power circuit to supply the electric power to the system control circuit and to the device connection port within the information processing apparatus will be described by use of FIGS. 2 through 5.

FIG. 2 is a diagram illustrating an example of how the power for the system control circuit and the power for the device connection port are generated by different power circuits. In FIG. 2, an information processing apparatus 1 includes power circuits 2a, 2b. The power circuits 2a, 2b are supplied with the electric power from a battery or an AC (Alternating Current) adaptor etc. The battery is, e.g., a lithium ion battery etc. for supplying the power to the information processing apparatus 1. The AC adaptor converts AC power led in from a socket into DC power, and supplies the electric power to the power circuits 2a, 2b. The power circuit 2a converts the electric power received from the battery or the AC adaptor etc. into the power for the system control circuit, and thus supplies the electric power to the system control circuit. The power circuit 2b converts the electric power received from the battery or the AC adaptor etc. into the power for the device connection port, and thus supplies the electric power to the device connection port. The information processing apparatus 1 can provide the USB charge function in the system shutdown state by being equipped with the different circuits. In the case of being equipped with the different power circuits, however, such inconvenience arises that both of a cost and a circuit packaging area for the power circuit for the device connection port increase.

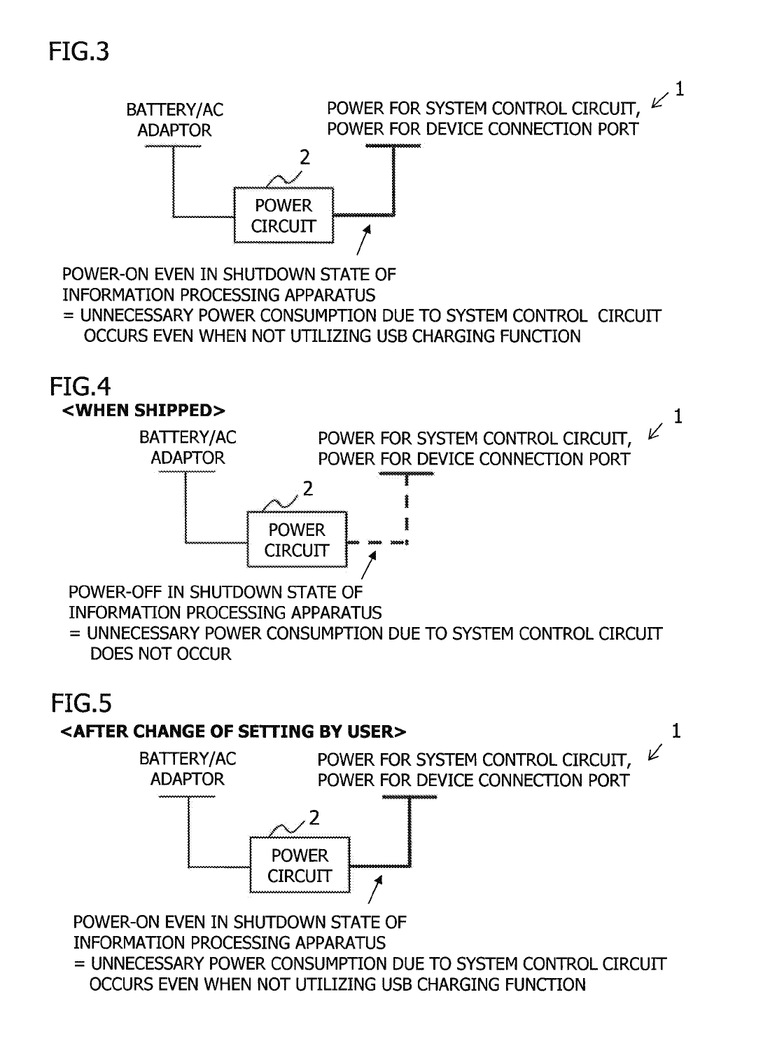

FIG. 3 is a diagram illustrating an example in the case of generating the power for the system control circuit and the power for the device connection port by a common power circuit. In FIG. 3, the information processing apparatus 1 includes a power circuit 2. The power circuit 2 is supplied with the electric power from the battery or the AC adaptor etc. The power circuit 2 converts the electric power received from the battery or the AC adaptor etc. into the power for the system control circuit and the power for the device connection port, and supplies the electric power to the system control circuit and to the device connection port. The information processing apparatus 1, for performing the USB charge even in a system shutdown state, supplies the electric power to the power source for the system control circuit and to the power source of the device connection port even when not utilizing the USB charge function. Therefore, the unnecessary power consumption due to the system control circuit always occurs even when not utilizing the USB charge function.

FIG. 4 is a diagram illustrating an example of an operation mode of the power circuit when shipping the information processing apparatus 1. In the case of using the common power circuit, for restraining the unnecessary power consumption, the power supply to the device connection port is set in a “Disable” state when shipped.

FIG. 5 is a diagram illustrating an example of the operation mode of the power circuit after the setting of the power supply to the device connection port has been changed to an “Enable” state. After being shipped, in order to perform the USB charge in the state where the system is not booted up, the setting of the power supply to the device connection port is changed to the “Enable” state from the “Disable” state under software control based on user's setting. After changing the setting, even in the system shutdown state, the information processing apparatus 1 supplies the electric power to the power source for the system control circuit and the power source for the device connection port.

### Concerning Transition of Power Supply State

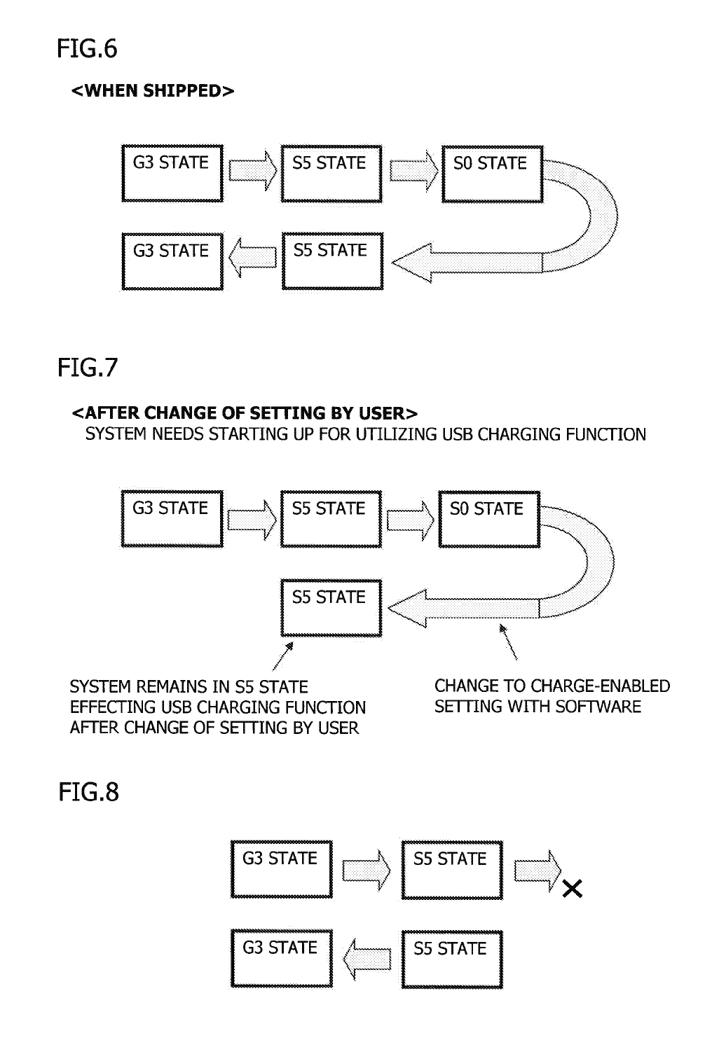

Next, a transition of the power supply state of the information processing apparatus will be described by use of FIGS. 6 through 8.

FIG. 6 is a diagram depicting the transition of the power supply state of the information processing apparatus when shipped with respect to the information processing apparatus according to a comparative example. The information processing apparatus 1 is in a G3 state when shipped. With a transition to an S5 state by pressing down the power button, the system is booted up as normal by the system control circuit, and the information processing apparatus 1 transitions to an S0 state. When a user performs a shutdown process, the information processing apparatus 1 transitions to the S5 state. When shipped, the setting of the power supply to the device connection port is the “Disable” state, and hence the information processing apparatus 1 transitions to the G3 state without remaining in the S5 state. Accordingly, the setting when shipped does not cause any occurrence of the unnecessary power consumption in the system shutdown state.

FIG. 7 is a diagram depicting a transition of the power supply state of the information processing apparatus on the occasion of changing the setting of the power supply to the device connection port in the information processing apparatus according to the comparative example. The transition to the S0 state from the G3 state is the same as when shipped. After booting up the information processing apparatus, the user changes the setting of the power supply to the device connection port to the “Enable” state by using a software program. When the user conducts the shutdown process, the information processing apparatus 1 transitions to the S5 state. The setting of the power supply to the device connection port is the “Enable” state, and therefore the information processing apparatus 1 remains in the S5 state even when instructed to shut down. Hereat, the USB charge is enabled in the state where the system is not yet booted up. However, an event that the user changes the setting of the power supply to the device connection port entails a procedure of temporarily booting up the information processing apparatus and shutting down the information processing apparatus after changing the setting by using the software program, resulting in poor usability.

Such being the case, in the working example, the charge button is provided, and the operation mode in FIGS. 4 and 5 is switched over by pressing down the charge button. FIG. 8 is a diagram depicting a transition of the power supply state of the information processing apparatus by switching ON and OFF the charge button. When the power-off USB charging function is set ON by pressing down the charge button, the information processing apparatus 1 transitions to the S5 state from the G3 state. At this time, the boot-up restraint setting of the system control circuit is set ON, and hence the information processing apparatus is not booted up. Next, when the power-off USB charging function is set OFF by pressing down the charge button, the information processing apparatus 1 transitions to the G3 state from the S5 state. In the case of not utilizing the USB charge function, the unnecessary power consumption does not occur by setting OFF the power-off USB charging function. Furthermore, the power-off USB charging function can be switched ON and OFF by an operation that is as simple as pressing down the charge button.

### Working Example

### Hardware Configuration

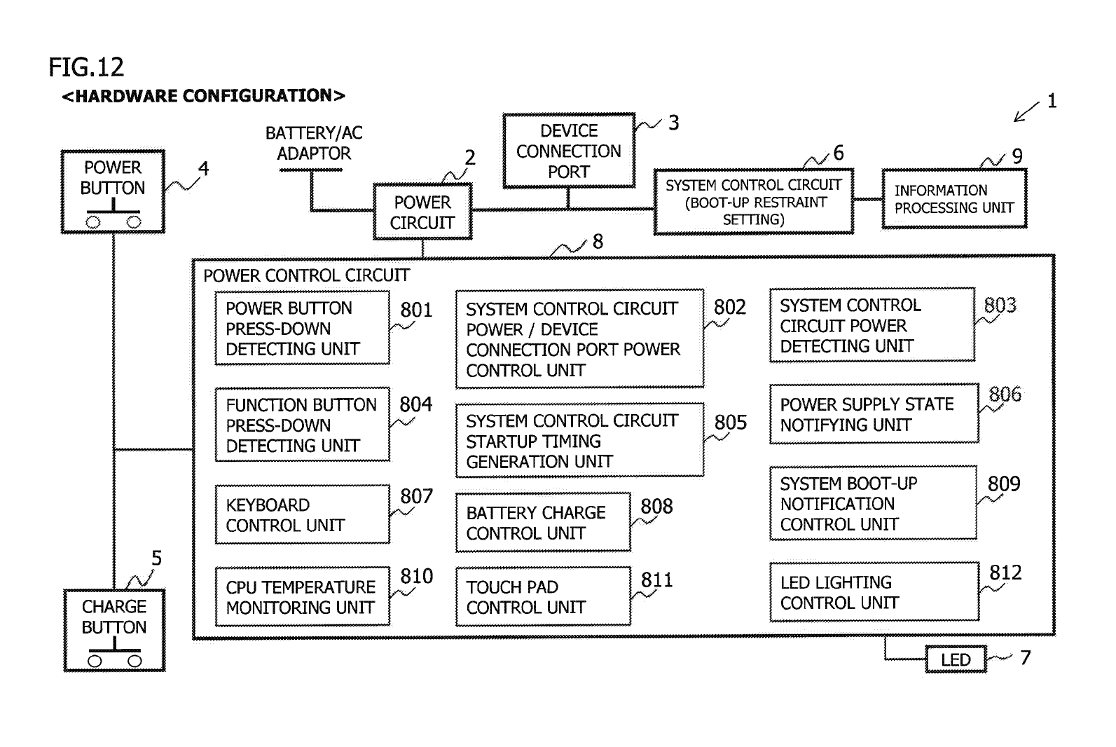

FIG. 12 is a diagram of a hardware configuration of the power control circuit according a working example. In FIG. 12, the information processing apparatus 1 includes a power circuit 2, a device connection port 3, a power button 4, a charge button 5, a system control circuit 6, an LED (Light Emitting Diode) 7, a power control circuit 8 and an information processing unit 9. Herein, the power button 4 is one example of a first switch. Further, the charge button 5 is one example of a second switch.

The power control circuit 8 includes a power button press-down detecting unit 801, a system control circuit power/device connection port power control unit 802, a system control circuit power detecting unit 803, a function button press-down detecting unit 804, a system control circuit startup timing generation unit 805, a power supply state notifying unit 806, a keyboard control unit 807, a battery charge control unit 808, a system boot-up notification control unit 809, a CPU temperature monitoring unit 810, a touch pad control unit 811 and a LED lighting control unit 812. The respective units of the power control circuit 8 are exemplified as hardware circuits that execute respective processes. At least some units of the power control circuit 8 may, however, be configured as processors such as a CPU and a DSP (Digital Signal Processor) to execute a control program or control circuits such as programmable logic controllers to implement sequence control.

The power circuit 2 is supplied with the electric power from the battery or the AC adaptor etc. The power circuit 2 generates the power for the device connection port 3 and the power for the system control circuit 6, and supplies the electric power to the device connection port 3 and the to the system control circuit 6. The device connection port 3 supplies the electric power received from the power circuit 2 to external devices such as a Smartphone and a music playback device.

The power button 4, when pressed down, instructs the power control circuit 8 to supply the electric power to the device connection port 3 and to the system control circuit 6. At this time, the boot-up restraint setting of the system control circuit 6 is set ON, thereby restraining the information processing apparatus 1 from being booted up. Upon receiving the instruction from the power button 4, the power control circuit 8 notifies the system control circuit 6 of the boot-up, thereby booting up the information processing apparatus 1 as normal.

The charge button 5, when pressed down, instructs the power control circuit 8 to supply the electric power to the device connection port 3 and to the system control circuit 6. In the case of receiving the instruction from the charge button 5, the boot-up restraint setting of the system control circuit 6 is set ON, and hence the information processing apparatus 1 is restrained from being booted up. The charge button 5, when again pressed down, instructs the power control circuit 8 to finish supplying the electric power to the device connection port 3 and to the system control circuit 6. Incidentally, it does not mean that a usage purpose of the electric power supplied to the device connection port 3 as the charge button 5 is pressed down is limited to the charge.

The system control circuit 6 is supplied with the electric power from the power circuit 2 and thus controls the boot-up of the information processing apparatus 1. In the working example, the system control circuit 6, with the boot-up restraint setting being set ON, does not boot up the information processing apparatus 1 simply by its being supplied with the electric power. The system control circuit 6, when receiving a system boot-up notifying signal from the power control circuit 8, boots up the information processing apparatus 1 as normal. The system control circuit 6 is exemplified by a chip-set adopted in, e.g., a personal computer, a server, etc. Note that the information processing unit 9 is connected to the system control circuit 6 in FIG. 12. The information processing unit 9 is an exemplification of a circuit working together with the system control circuit 6 in the information processing apparatus 1. The information processing unit 9 includes, e.g., a CPU (Central Processing Unit), a main storage device, etc. When the power button 4 is pressed down, the power control circuit 8 supplies the electric power also to the information processing unit 9, and the system control circuit 6 sends a boot-up command to the information processing unit 9, thereby booting up the information processing apparatus 1.

The LED 7 lights up when pressing down the charge button 5 and a power supply state of the information processing apparatus 1 transitions to the S5 state, there indicating a state that the USB charge is enabled. The LED 7 is extinguished when the charge button 5 is again pressed down and the power supply state of the information processing apparatus 1 transitions to the G3 state, thereby indicating a state that the USB charge is disabled.

The power control circuit 8 detects the press-down of the charge button 5 or the power button 4. Further, the power control circuit 8 transmits a power control signal for indicating a start or an end of the power supply to the power circuit 2, thereby controlling the power supply to the device connection port 3, the system control circuit 6 and the LED 7. The power control circuit 8 is, e.g., a PMU (Power Management Unit) or an EC (Embedded Controller).

The power button press-down detecting unit 801 detects that the power button 4 is pressed down and notifies the system control circuit power/device connection port power control unit 802 that the power button 4 is pressed down. Moreover, the power button press-down detecting unit 801 notifies the power supply state notifying unit 806 that the power button 4 is pressed down.

The system control circuit power/device connection port power control unit 802 accepts, from the power button press-down detecting unit 801, notification purporting that the power button 4 is pressed down. Furthermore, the system control circuit power/device connection port power control unit 802 accepts, from the function button press-down detecting unit 804, notification purporting that the charge button 5 is pressed down. When receiving the notification from the power button press-down detecting unit 801 or the function button press-down detecting unit 804, the system control circuit power/device connection port power control unit 802 transmits the power control signal for indicating the start of the power supply to the power circuit 2.

The system control circuit power detecting unit 803 detects the start and the end of the power supply to the device connection port 3 and the system control circuit 6 from the power circuit 2. The system control circuit power detecting unit 803 notifies the power supply state notifying unit 806 of the start and the end of the power supply.

The function button press-down detecting unit 804 detects that a function button, e.g., the charge button 5 in the working example is pressed down, and notifies the system control circuit power/device connection port power control unit 802 that the charge button 5 is pressed down. Further, the function button press-down detecting unit 804 notifies the power supply state notifying unit 806 that the charge button 5 is pressed down.

The system control circuit startup timing generation unit 805 adjusts, e.g., a variety of timings for such as the notification to the power supply state notifying unit 806 from the system control circuit power detecting unit 803.

The power supply state notifying unit 806 notifies the system control circuit 6 of the start and the end of the power supply. When the charge button 5 is pressed down, the power supply state notifying unit 806 notifies the LED lighting control unit 812 that the charge button 5 is pressed down and that the power supply is started. The LED lighting control unit 812 receiving the notification lights up the LED 7. Moreover, the power supply state notifying unit 806 notifies the LED lighting control unit 812 that the charge button 5 is again pressed down and that the power supply is ended. The LED lighting control unit 812 receiving the notification extinguishes the LED 7.

When the power button 4 is pressed down, the power supply state notifying unit 806 notifies the system boot-up notification control unit 809 that the power button 4 is pressed down. The system boot-up notification control unit 809 receiving the notification transmits a system boot-up notifying signal to the system control circuit 6, thereby booting up the information processing apparatus 1.

The keyboard control unit 807 controls a process in the case of accepting an input from a keyboard. The battery charge control unit 808 controls a battery charge. The CPU temperature monitoring unit 810 monitors a temperature of the CPU. The touch pad control unit 811 controls a process in the case of accepting an input from a touch pad.

### Control of Power Control Circuit

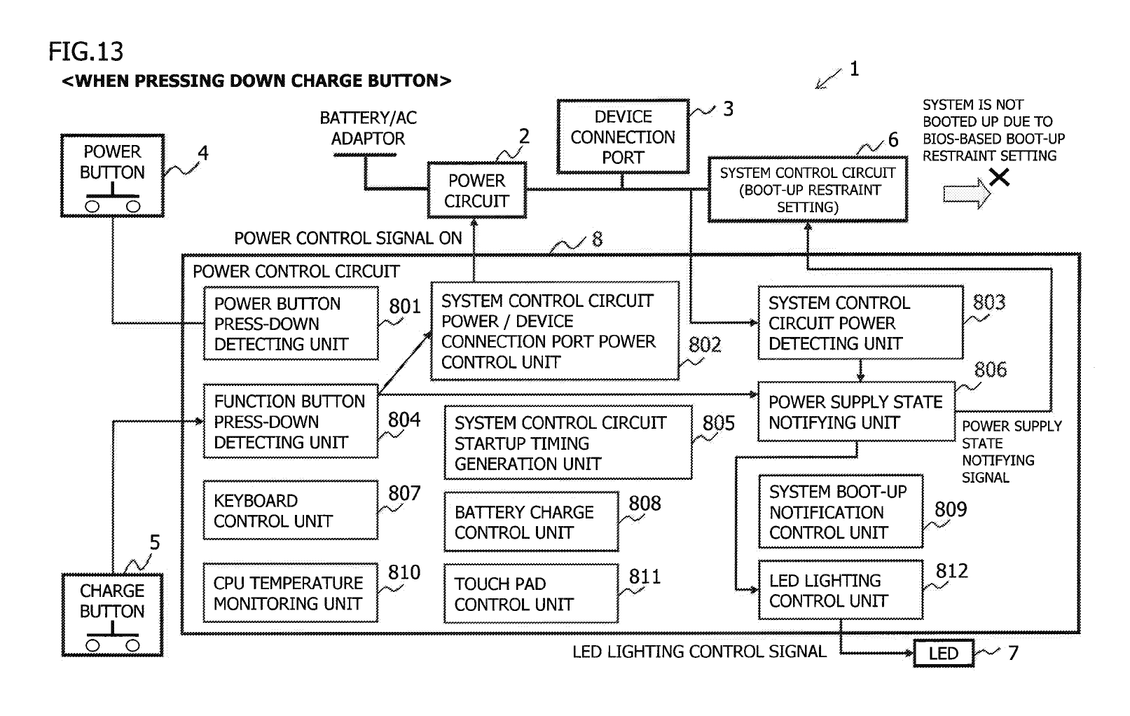

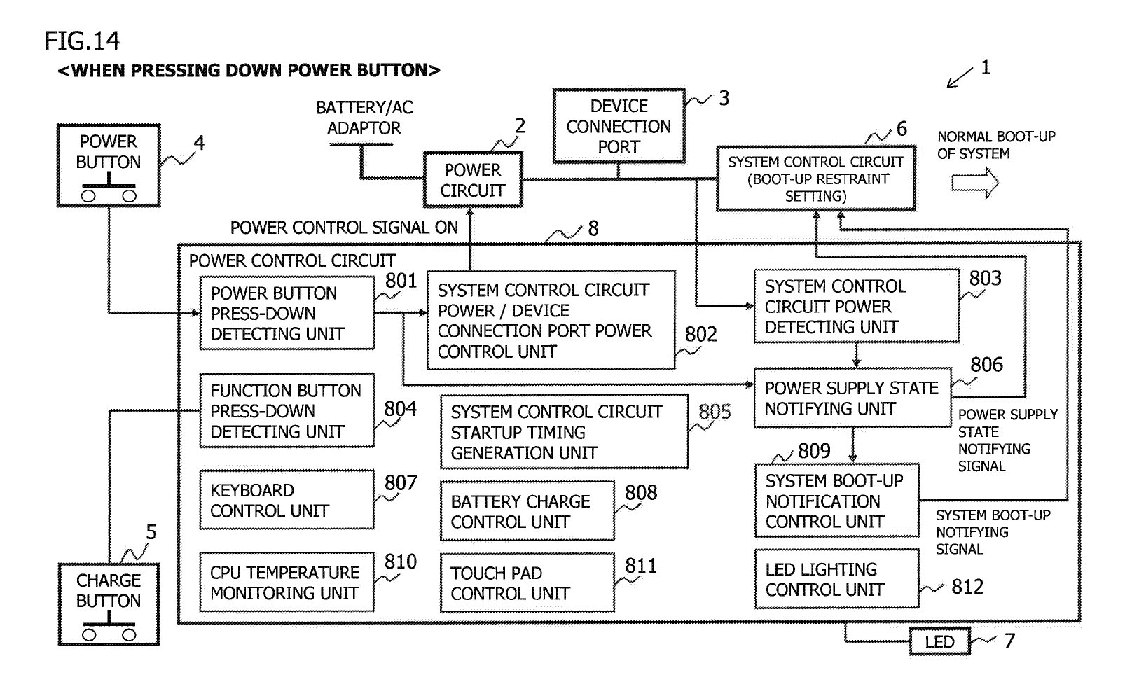

Described by use of FIGS. 13 and 14 is control of the power control circuit 8 when pressing down the charge button 5 and when pressing down the power button 4. Note that the information processing unit 9 is omitted in FIGS. 13 and 14.

FIG. 13 is a diagram illustrating one example of how the power control circuit performs controlling when pressing down the charge button 5 according to the working example. When the charge button 5 is pressed down, the function button press-down detecting unit 804 detects that the charge button 5 is pressed down. The function button press-down detecting unit 804 notifies the system control circuit power/device connection port power control unit 802 and the power supply state notifying unit 806 that the charge button 5 is pressed down. The system control circuit power/device connection port power control unit 802 transmits a power control signal for indicating the start of the power supply to the power circuit 2.

When starting the power supply to the device connection port 3 and to the system control circuit 6 from the power circuit 2, the system control circuit power detecting unit 803 notifies the power supply state notifying unit 806 that the power supply is started. The power supply state notifying unit 806 transmits, to the system control circuit 6, a power supply state notifying signal for notifying that the power supply is started. The system control circuit 6, with the boot-up restraint setting being set ON, restrains the information processing apparatus 1 from being booted up. Further, the power supply state notifying unit 806 notifies the LED lighting control unit 812 that the charge button 5 is pressed down and that the power supply is started. The LED lighting control unit 812 transmits, to the LED 7, an LED lighting control signal for notifying that the charge button 5 is pressed down and that the power supply is started. The LED 7 lights up when receiving the LED lighting control signal.

FIG. 14 is a diagram illustrating one example of how the power control circuit performs controlling when pressing down the power button according to the working example. When the power button 4 is pressed down, the power button press-down detecting unit 801 detects that the power button 4 is pressed down. The power button press-down detecting unit 801 notifies the system control circuit power/device connection port power control unit 802 and the power supply state notifying unit 806 that the power button 4 is pressed down. The system control circuit power/device connection port power control unit 802 transmits, to the power circuit 2, a power control signal for indicating the start of the power supply.

When starting the power supply to the device connection port 3 and to the system control circuit 6 from the power circuit 2, the system control circuit power detecting unit 803 notifies the power supply state notifying unit 806 that the power supply is started. The power supply state notifying unit 806 transmits, to the system control circuit 6, a power supply state notifying signal for notifying that the power supply is started. Furthermore, the power supply state notifying unit 806 notifies the system boot-up notification control unit 809 that the power button 4 is pressed down and that the power supply is started. The system boot-up notification control unit 809 transmits a system boot-up notifying signal for indicating the boot-up of the information processing apparatus 1 to the system control circuit 6. The system control circuit 6 receiving the system boot-up notifying signal boots up the information processing apparatus 1 as normal even when the boot-up restraint setting is set ON.

### Control of Power Control Circuit in Comparative Example

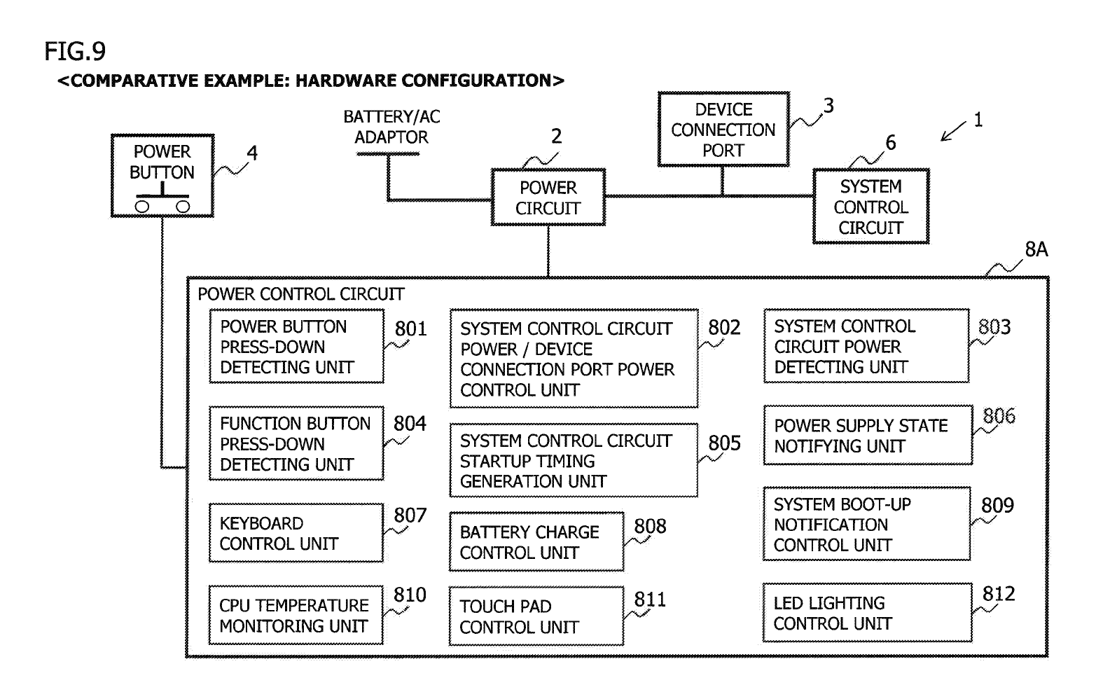

Herein, the control of a power control circuit 8A according to a comparative example will be described by use of FIGS. 9 through 11. FIG. 9 is diagram of a hardware configuration of the power control circuit 8A according to the comparative example. The hardware configuration is the same as the configuration of the power control circuit 8 according to the working example in FIG. 12 except a point of not including the charge button 5 and the LED 7, and hence their explanations are omitted. Further, the information processing unit 9 is omitted also in FIGS. 9 through 11.

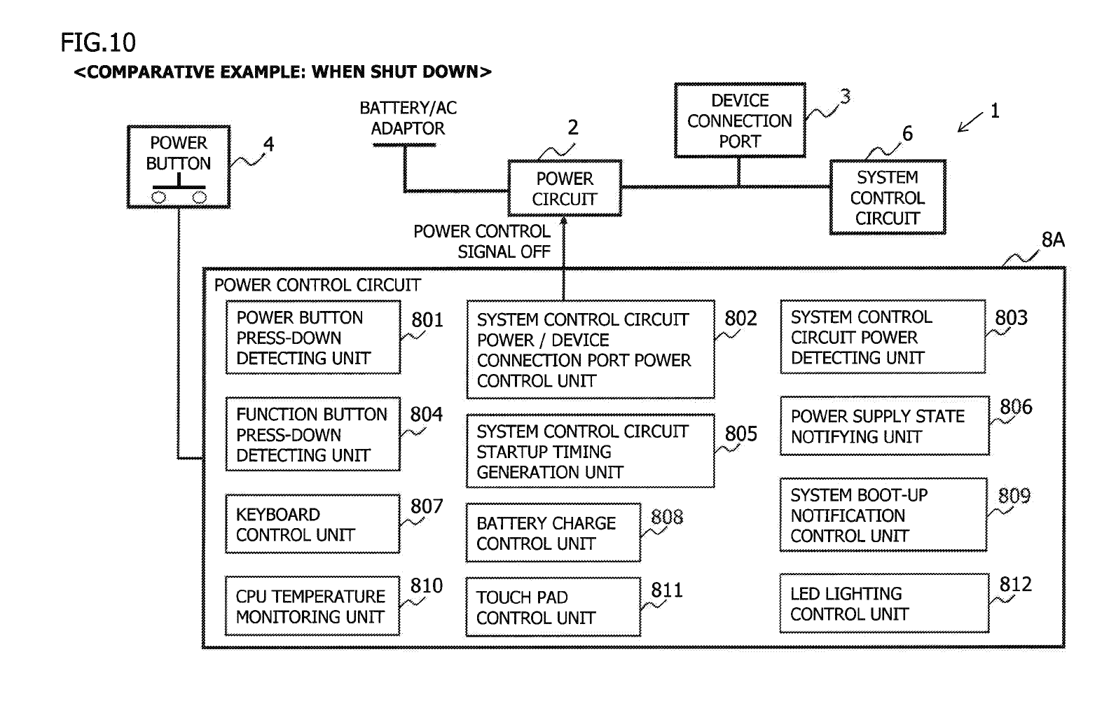

FIG. 10 is a diagram illustrating how the power control circuit 8A performs controlling when shut down according to the comparative example. In FIG. 10, the system control circuit power/device connection port power control unit 802, upon receiving “shutdown” notification from the information processing apparatus 1, transmits the power control signal for indicating the end of the power supply to the power circuit 2. Ended is the power supply to the device connection port 3 and to the system control circuit 6 from the power circuit 2.

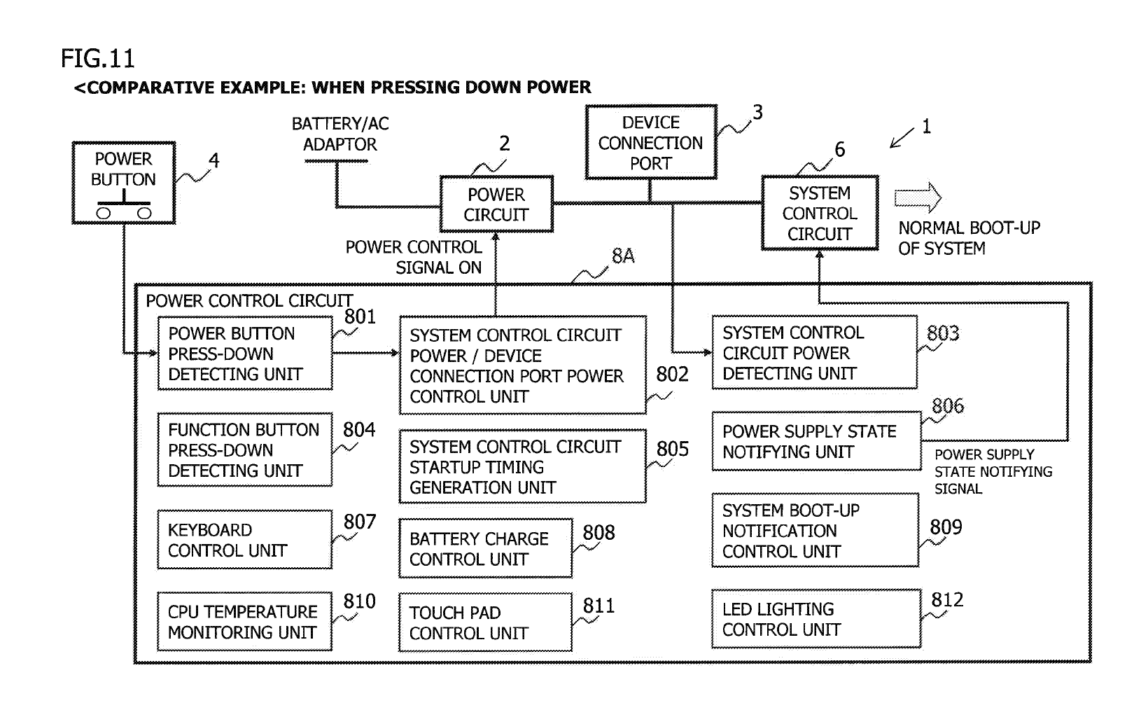

FIG. 11 is a diagram illustrating how the power control circuit 8A performs controlling when pressing down the power button according to the comparative example. When the power button 4 is pressed down, the power button press-down detecting unit 801 detects that the power button 4 is pressed down. The power button press-down detecting unit 801 notifies the system control circuit power/device connection port power control unit 802 and the power supply state notifying unit 806 that the power button 4 is pressed down. The system control circuit power/device connection port power control unit 802 transmits the power control signal for indicating the start of the power supply to the power circuit 2.

When the power circuit 2 starts supplying the electric power to the device connection port 3 and to the system control circuit 6, the system control circuit power detecting unit 803 notifies the power supply state notifying unit 806 that the power supply is started. The power supply state notifying unit 806 transmits, to the system control circuit 6, a power supply state notifying signal for notifying that the power supply is started. The system control circuit 6 boots up the information processing apparatus 1 as normal.

In the working example, with the charge button 5 being pressed down, the information processing apparatus 1 transitions to S5 state. On the other hand, in the comparative example, with the power button 4 being pressed down, the information processing apparatus 1, after temporarily transitioning to S0 state, transitions to S5 state by switching over the setting of the power supply to the device connection port 3 to the “Enable” state under software control based on the user's setting and conducting the shutdown. In this case, such a procedure occurs that the user boots up the information processing apparatus 1, changes the setting of the power supply to the device connection port 3 and shuts down the information processing apparatus 1, resulting in causing inconvenience, i.e., the poor usability. Moreover, if the setting of the power supply to the device connection port is set always in the “Enable” state, it follows that the system control circuit consumes the futile standby power even when not utilizing the USB charging function.

### Processing Flow

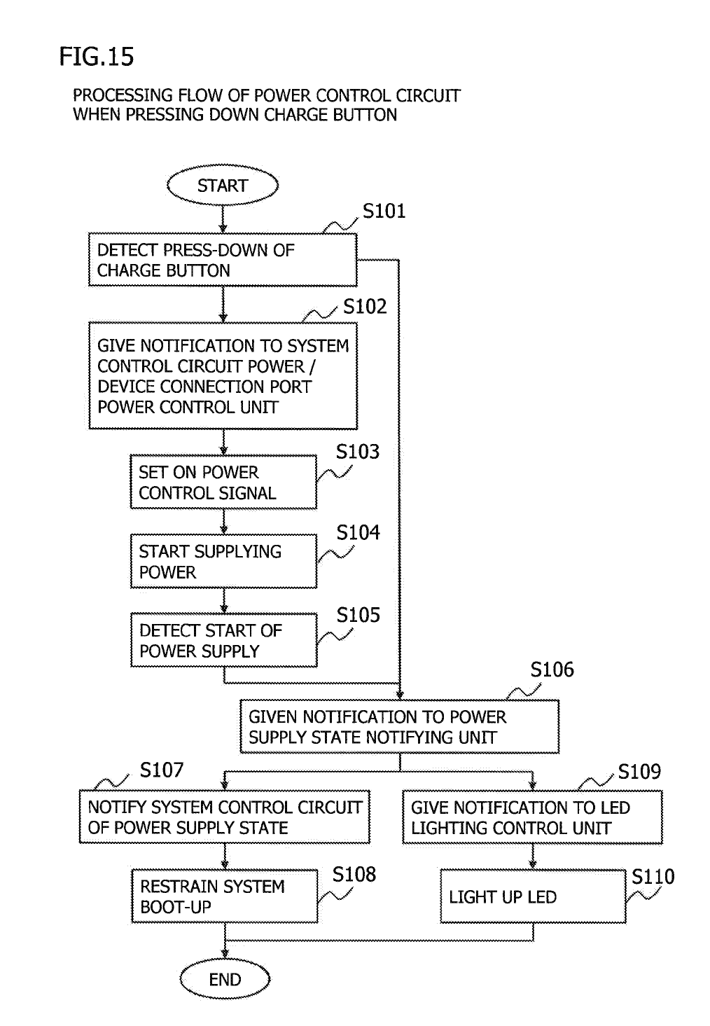

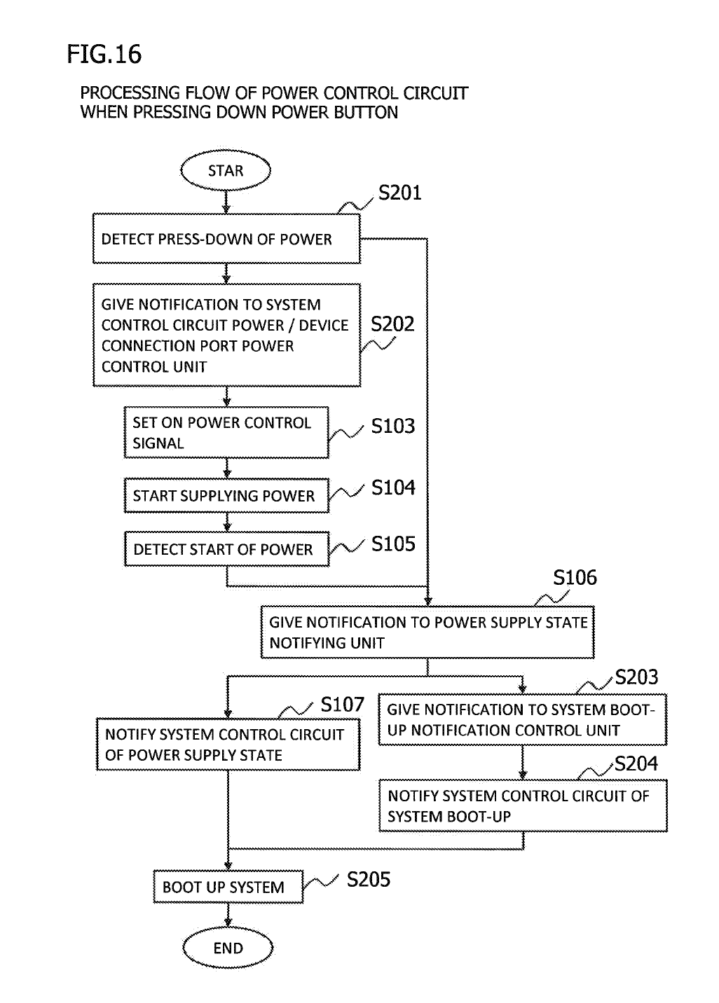

A processing flow of the power control circuit 8 when pressing down the charge button 5 and when pressing down the power button 4, will be described by use of FIGS. 15 and 16. The processing flow given below is implemented in such a way that the respective components of the power control circuit 8 work with each other by, e.g., transmitting and receiving electric signals.

FIG. 15 is a flowchart illustrating the processing flow of the power control circuit 8 in a case where the power supply to the device connection port is started by pressing down the charge button 5. The power control circuit 8, when the second switch accepts the instruction of the power supply in a state of the first switch not accepting the instruction of the power supply, executes processes in step S101 through step S110 by way of one example of restraining the boot-up of the information processing unit and supplying the electric power to the device connection port.

In step S101, the function button press-down detecting unit 804 detects that the charge button 5 is pressed down. In step S102, the function button press-down detecting unit 804 notifies the system control circuit power/device connection port power control unit 802 that the charge button 5 is pressed down. In step S103, the system control circuit power/device connection port power control unit 802 transmits the power control signal for indicating the start of the power supply to the power circuit 2. In step S104, the power circuit 2 starts supplying the electric power to the device connection port 3 and to the system control circuit 6. In step S105, the system control circuit power detecting unit 803 detects that the power supply is started.

In step S106, the system control circuit power detecting unit 803 notifies the power supply state notifying unit 806 that the power supply is started. In step S107, the power supply state notifying unit 806 transmits, to the system control circuit 6, the power supply state notifying signal for notifying that the power supply is started. In step S108, the system control circuit 6, with the boot-up restraint setting being set ON, restrains the information processing apparatus 1 from being booted up. Herein, the term “restraint” connotes that the system control circuit 6 does not boot up the system such as an OS (Operating System) in the information processing unit 9 in, e.g., FIG. 12.

Further, in step S109, the function button press-down detecting unit 804 notifies the power supply state notifying unit 806 that the charge button 5 is pressed down. In step S109, the power supply state notifying unit 806 notifies the LED lighting control unit 812 that the charge button 5 is pressed down and that the power supply is started. In step S110, the LED lighting control unit 812 lights up the LED 7. The power control circuit 8 finishes processing when pressing down the charge button 5, thereby enabling the USB charge to be utilized.

FIG. 16 is a flowchart illustrating a processing flow of the power control circuit 8 when pressing down the power button 4. The power control circuit 8 executes processes in step S201 through step S205 byway of one example of supplying the electric power to the device connection port and booting up the information processing unit when accepting the instruction of the power supply by the first switch.

In step S201, the power button press-down detecting unit 801 detects that the power button 4 is pressed down. In step S202, the power button press-down detecting unit 801 notifies the system control circuit power/device connection port power control unit 802 that the power button 4 is pressed down. The processes in step S103 through step S105 are the same as in the processing flow when pressing down the charge button 5.

In step S106, the system control circuit power detecting unit 803 notifies the power supply state notifying unit 806 that the power supply is started. In step S107, the power supply state notifying unit 806 transmits, to the system control circuit 6, the power supply state notifying signal for notifying that the power supply is started.

Moreover, in step S106, the power button press-down detecting unit 801 notifies the power supply state notifying unit 806 that the power button 4 is pressed down. In step S203, the power supply state notifying unit 806 notifies the system boot-up notification control unit 809 that the power button 4 is pressed down. In step S204, the system boot-up notification control unit 809 transmits, to the system control circuit 6, a system boot-up notifying signal for indicating the boot-up of the information processing apparatus 1. In step S205, when receiving the power supply state notifying signal and the system boot-up notifying signal, the system control circuit 6 boots up the information processing apparatus 1 even if the boot-up restraint setting is set ON. To be specific, the system control circuit 6 boots up the system such as the OS, e.g., in the information processing unit 9 in FIG. 12. Then, the power control circuit 8 finishes processing when pressing down the power button 4.

Such a problem inherent in the prior arts exists that the different power circuits are provided separately for the power source for the system control circuit and the power source of the device connection port, resulting in increases in cost and in packaging area. Additionally, the function is poor in usability because of such setting that the power supply to the device connection port is set in the “Disable” state under the software control based on the user's setting for restraining the futile power consumption when not utilizing the charge function. The present working example involves implementing the boot-up restraint setting of the system control circuit 6, i.e., implementing the ON/OFF switchover of the function by a hardware setting. This contrivance makes an addition of the circuit unnecessary and facilitates downsizing the apparatus. Further, it is feasible to restrain the power consumption when not utilizing the function. Still further, the usability for the user can be improved.

### First Modified Example

In the working example, as illustrated in FIG. 14, the system control circuit 6, when receiving the system boot-up notifying signal from the system boot-up notification control unit 809, boots up the information processing apparatus 1 as normal. However, a determination as to whether the information processing apparatus 1 is booted up as normal or not may be made by distinguishing which button, the charge button 5 or the power button 4, is pressed down but may not be based on whether the system boot-up notifying signal is transmitted or not. In a first modified example, even without the boot-up restraint setting in the system control circuit 6, it determined whether the information processing apparatus 1 is booted up as normal, the determination being made based on whether or not the power supply state notifying signal for the system control circuit 6 is received from, e.g., the power supply state notifying unit 806.

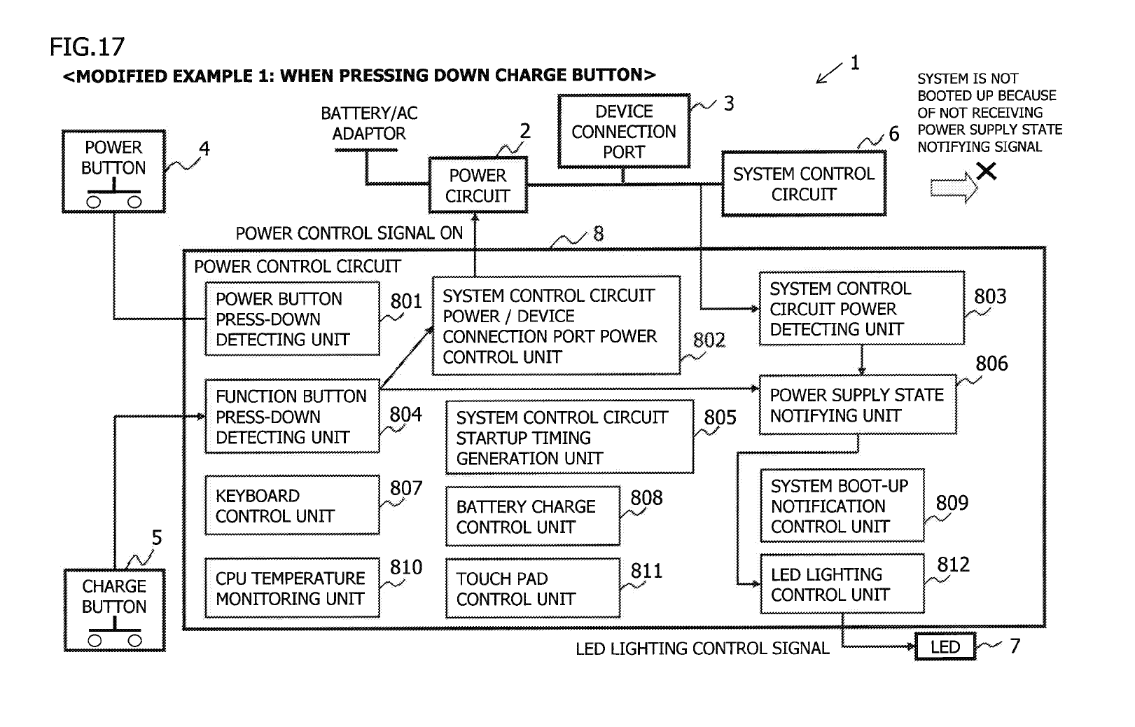

FIG. 17 is a diagram illustrating one example of how the power control circuit 8 performs controlling when pressing down the charge button 5 according to the first modified example. When the charge button 5 is pressed down, the function button press-down detecting unit 804 detects that the charge button 5 is pressed down. The function button press-down detecting unit 804 notifies the system control circuit power/device connection port power control unit 802 and the power supply state notifying unit 806 that the charge button 5 is pressed down. The system control circuit power/device connection port power control unit 802 transmits the power control signal for indicating the start of the power supply to the power circuit 2.

When power circuit 2 starts supplying the electric power to the device connection port 3 and to the system control circuit 6, the system control circuit power detecting unit 803 notifies the power supply state notifying unit 806 that the power supply is started. The power supply state notifying unit 806, in the case of the charge button 5 being pressed down, does not transmit the power supply state notifying signal for notifying that the power supply is started to the system control circuit 6. Accordingly, the system control circuit 6 does not boot up the information processing apparatus 1. The lighting of the LED 7 is the same as in the working example, and hence its description is omitted.

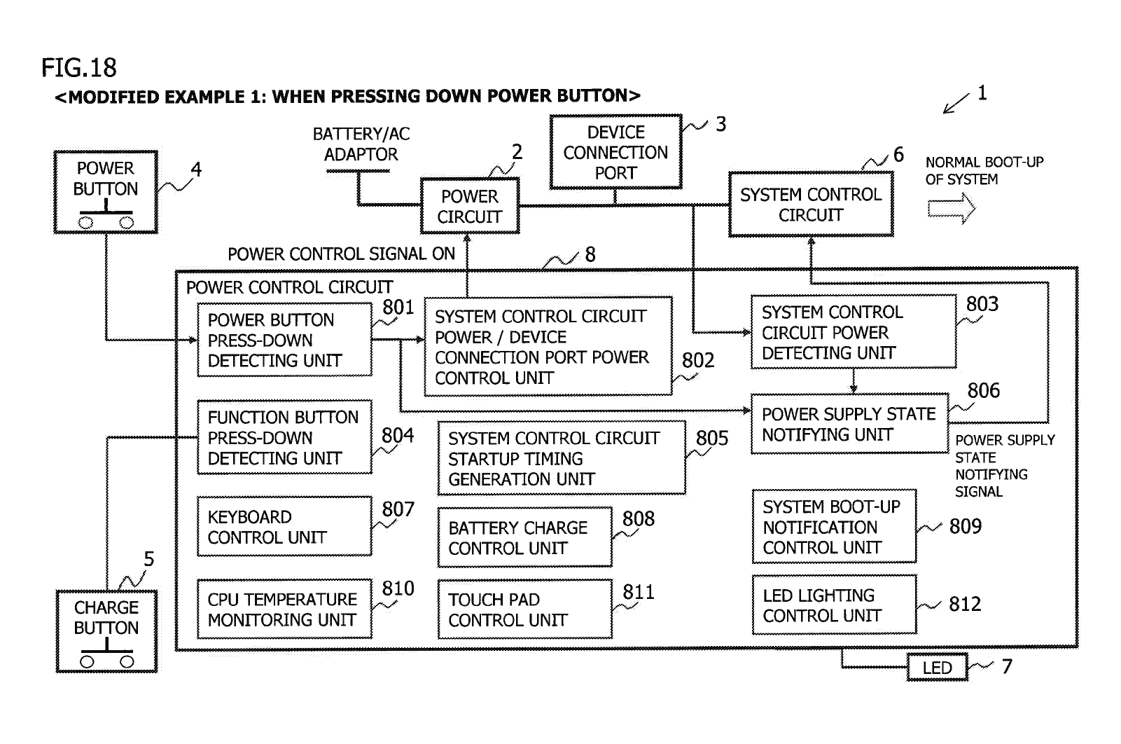

FIG. 18 is a diagram illustrating one example of how the power control circuit 8 performs controlling when pressing down the power button 4 according to the first modified example. When the power button 4 is pressed down, the power button press-down detecting unit 801 detects that the power button 4 is pressed down. The power button press-down detecting unit 801 notifies the system control circuit power/device connection port power control unit 802 and the power supply state notifying unit 806 that the power button 4 is pressed down. The system control circuit power/device connection port power control unit 802 transmits the power control signal for indicating the start of the power supply to the power circuit 2.

When the power circuit 2 starts supplying the electric power to the device connection port 3 and to the system control circuit 6, the system control circuit power detecting unit 803 notifies the power supply state notifying unit 806 that the power supply is started. The power supply state notifying unit 806 transmits the power supply state notifying signal for notifying that the power supply is started to the system control circuit 6. The system control circuit 6 receiving the power supply state notifying signal boots up the information processing apparatus 1 as normal due to none of the boot-up restraint setting.

### Second Modified Example

In the working example, the information processing apparatus 1 switches ON/OFF the power-off USB charging function by pressing down the charge button 5. The ON/OFF switching of the power-off USB charging function may not be based on the press-down of the charge button 5 if distinguishable from the press-down of the power button 4. For example, the power control circuit 8 can conduct the control illustrated in FIG. 13 by pressing down, e.g., a specified key of the keyboard.

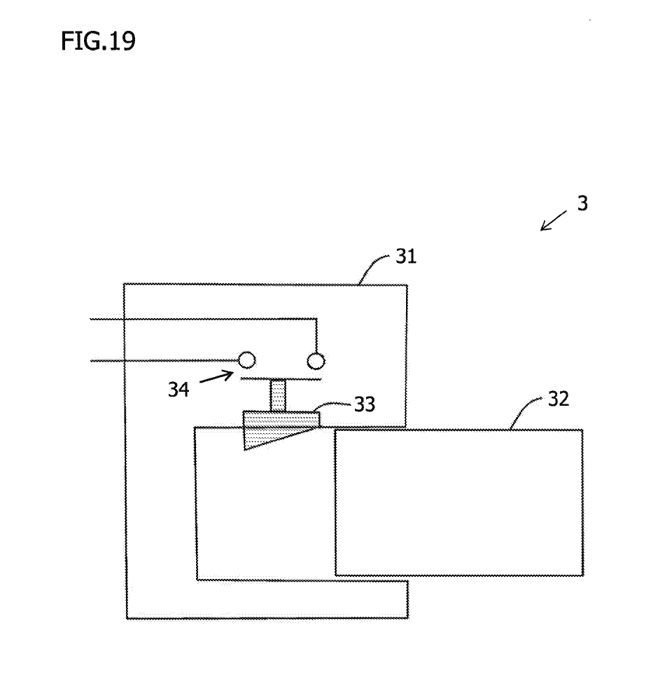

Further, for instance, a switch provided within the device is pressed down by, e.g., a metal shell unit of a USB device, thereby enabling the power control circuit 8 to perform the control illustrated in FIG. 13. FIG. 19 depicts a structure of the switch provided within the device connection port 3 of the USB device etc. The device connection port 3 in FIG. 19 includes, e.g., a female connector 31 connected to a circuit board of the information processing apparatus 1. A male connector 32 is inserted into the female connector 31, whereby the external device is connected to the information processing apparatus 1. Moreover, the device connection port 3 in FIG. 19 is provided with a pressing mechanism 33 that establishes an ON-connection with the switch 34 by pressing the male connector 32 when the male connector 32 is connected to the female connector 31. With such a configuration, the information processing apparatus 1 detects that the male connector 32 is attached to the device connection port 3, and the power circuit 2 can supply the electric power to the device connection port 3 without booting up the system of the information processing apparatus 1.

According to the technology of the disclosure, it is feasible to supply, in the information processing apparatus configured to supply the electric power to the main body apparatus and to the device connection port from the common power circuit, the electric power from the device connection port also in the non-booting state of the information processing apparatus by switching over the ON/OFF states for supplying the electric power to the device connection port while restraining the information processing apparatus from being booted up.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a power circuit;
a system control circuit to be supplied with electric power from the power circuit;
an information processing unit configured to be booted up by the system control circuit supplied with the electric power;
a device connection port to supply the electric power received from the power circuit to an external device;
a first switch to accept a first instruction of power supply to the system control circuit from the power circuit;
a second switch to accept a second instruction of the power supply to the device connection port from the power circuit; and
a power control circuit to supply the electric power to the device connection port from the power circuit with the system control circuit booting up the information processing unit when accepting the first instruction of the power supply by the first switch, and to supply the electric power to the device connection port from the power circuit with the system control circuit restraining the information processing unit from being booted up when accepting the second instruction of the power supply by the second switch in a state of the first switch not accepting the first instruction of the power supply.

2. The information processing apparatus according to claim 1, wherein the second switch is a switch to detect a connecting operation when a connector with the external device is connected to the device connection port.

3. A power control method comprising:
supplying electric power to a device connection port and booting up an information processing unit when accepting a first instruction of power supply by a first switch; and
supplying the electric power to the device connection port and restraining the information processing unit from being booted up when accepting a second instruction of power supply by a second switch in a state of the first switch not accepting the first instruction of the power supply

4. A non-transitory computer-readable recording medium having stored therein a program for causing a computer to execute a power control process comprising:
supplying electric power to a device connection port and booting up an information processing unit when accepting a first instruction of power supply by a first switch; and
supplying the electric power to the device connection port and restraining the information processing unit from being booted up when accepting a second instruction of power supply by a second switch in a state of the first switch not accepting the first instruction of the power supply.
